(19) United States
(12) Patent Application Publication
(10) Pub. No.: US 2012/0018994 A1
(43) Pub. Date: Jan. 26, 2012

(54) LOTTERY TICKET WITH HOLOGRAPHIC APPEARANCE

(76) Inventors: Scott Thomas Stalker, Dexter, MI (US); David Joseph Thomas, Ypsilanti, MI (US); Derek Victor LaRose, Ypsilanti, MI (US)

(21) Appl. No.: 12/842,604

(22) Filed: Jul. 23, 2010

(51) Int. Cl. B42D 15/00; A63B 71/00

(52) U.S. Cl. 283/100; 273/139

(57) ABSTRACT

A lottery ticket is formed by a substrate layer with game data printed in a game area with a fixing layer applied over the game data and a scratch-off layer applied over the sealing layer, the scratch-off layer being arranged to separate from the sealing layer and break down into fragments when scratched by a player. A UV curable varnish is printed onto the opaque scratch-off layer either as a single block or as separate patterns. While the varnish remains uncured, an exposed surface of the varnish is contacted and nipped with a surface of a film which has the surface thereof embossed to form a pattern and with the film in contact with the varnish, the varnish is cured by UV light through the film so as to apply the pattern of the film into the surface of the varnish to provide a holographic appearance.

The present invention relates generally to the field of game or lottery tickets which include a scratch-off layer covering game indicia which can be exposed by the player removing the layer for playing of the game or lottery.

The game provided on each substrate sheet may be for prizes both monetary and product related or may be merely for entertainment where no gambling or prize is involved. The type and value of any prizes can vary widely. The games may be predetermined otherwise known as “instant win” tickets or may include elements of skill or chance.

The games concerned are preferably instant win type games where the result is entirely predetermined, since such games are generally preferred in a lottery situation in order to ensure that the total winnings is predetermined. However the present invention is not limited to the type of game to be played and can include probability or other games which include game indicia covered by a scratch-off coating.

The construction may also be used in situations where the main objective is for other purposes than gambling such as in promotional games or games of fun for children or others where no gambling or prizes are involved.

Many such tickets are used directly in a lottery situation so that the tickets have no other relevance other than the playing of the lottery or game by which the player may win monetary or other prizes as part of the lottery or gaming situation. However attention has been recently given to other uses of such tickets such as promotional items used by manufacturers of other products to enhance the sale of the product, or as part of packaging or in other situations where the substrate acts in another capacity and the lottery ticket aspect is merely one part of its function.

The marketing of lottery tickets is primarily based on the psychology of impulse buying so that the ticket itself must be inherently attractive to the potential customer sufficiently to trigger the sale. Particular attention therefore applied to generating attractive graphics and an attractive appearance of the game face of the ticket.

For this reason high quality graphics and full four colour printing are used in the printing of the product. This is of particular importance in the area surrounding or directly over the game data.

Tickets of this type primarily utilize scratch-off technology for covering the game data and techniques for applying the scratch-off coating in a manner which provides the necessary protection and security for the game data have become well established. Thus tickets of this type generally include a substrate layer with game data printed in a game area and which is arranged to prevent access to the game data from a rear surface of the substrate. At least one fixing layer is applied over the game data in the game area so as to prevent release of the printed game data from the substrate layer and at least one opaque scratch-off layer is applied over the sealing layer, the scratch-off layer being arranged such that it separates from the sealing layer and breaks down into fragments when scratched by a player. On top of the scratch-off coating it is common to print additional graphics, often in four colour printing for the purposes of providing the required attractive appearance of the ticket.

It is also known that metalized coatings can be applied to products to provide a reflective appearance which yet further enhances the attractiveness and eye-appeal of the product concerned. Attempts have therefore been made to manufacture lottery tickets which have a metalized or reflective appearance at particular locations on the ticket. Up until now, however, such tickets have been manufacture by utilizing a substrate which is itself formed with a metalized or reflective layer. The printing is then applied on to the metalized layer which printing includes the necessary coatings, for defining the game area, for applying the game indicia and for covering the game indicia with a secure scratch-off coating. Thus tickets of this type often have the metalized or reflective areas in those locations where no printing has been applied and therefore in those areas which are remote form the game indicia. Alternatively, the printing onto a metalized or foil laminated substrate has used an arrangement in which the game data is either printed directly onto the foil or onto a screened white lily pad in the game area so that the ticket retains a metallic appearance in the game area due to this technique. While such tickets have been manufactured, the improvements in attractiveness have generally been insufficient to warrant the additional expense of utilizing the reflective or holographic substrate. Thus such tickets printed onto holographic substrates carry a very high cost and thus are limited to high end products or special events such as Christmas tickets.

Reflective substrates of this type can be embossed with areas of a particular reflective angle so that the surface appears to change as the angle of viewing varies across the surface. This technique is commonly known as “holographic” and is used on many products to define a surface which is highly attractive to the eye.

Up till now most holographic lottery tickets have been manufactured using the above technique in which the substrate itself is holographic and the printed layers are applied on top of the holographic substrate.

The manufacturer of lottery tickets of this type requires a high level of sophistication to ensure the proper levels of security. The ticket must be immune to attack by various techniques including high levels of reflected or transmitted light, attempts to lift or perforate the scratch off coating, chemical or liquid attacks, all of which are designed to expose the game data without removing the scratch-off coating in a manner which indicates that the ticket has been played. Many such lottery tickets have high prize values so that the incentive to breach the security is very high. Certain laboratories have therefore been established to attempt to breach the security of all lottery tickets with only those that pass the rigorous testing being acceptable for sale to the marketplace.

Yet further it is necessary for lottery tickets to have a shelf life of up to two years without degradation of the product leading to the security being breached or the scratch-off coating being difficult to remove.

In order therefore to manufacture an acceptable ticket it is necessary to provide all of the above features.

In U.S. Pat. No. 7,455,323 (Taylor et al) issued Nov. 25, 2008 to the present applicant is disclosed a lottery ticket of the above type which is modified by the addition of an adhesive layer applied over at least a part of the opaque scratch-off layer and a metal layer attached to the adhesive layer. The metal layer and the adhesive layer are arranged such that they break down into fragments with the scratch-off layer when scratched by the player and may provide both enhanced security and an improved appearance.

PCT Published application WO 02/094474 (Holmes) assigned to DE LA RUE International and published 21 Nov. 2002 discloses a technique in which a complex multi-layer scratch-off material is transferred from a carrier layer onto an underlying substrate such as a lottery ticket so as to cover the game data.

### SUMMARY OF THE INVENTION

It is one object of the present invention therefore to provide an improved lottery ticket which has a holographic appearance over at least a part of the game data.

According to one aspect of the invention there is provided a method of manufacturing a lottery ticket comprising:

providing a substrate layer;

defining a game area on a front surface of the substrate layer printing indicia defining game data on the substrate layer in the game area;

applying at least one opaque scratch-off layer over the game data,

applying a curable varnish on to an exposed surface of said at least one opaque scratch-off layer;

while the varnish remains uncured, contacting an exposed surface of the varnish with a surface of a film which has the surface thereof embossed to form a pattern;

and, with the film in contact with the varnish, curing the varnish so that the varnish is cured with the pattern of the film formed into the surface of the varnish;

said at least one opaque scratch-off layer with the varnish thereon being arranged such that the scratch-off layer and the varnish separate from the sealing layer and break down into fragments when scratched by a player.

Preferably the varnish is cured by UV but other methods of curing can be used.

Preferably the film is transparent and the varnish is cured by radiation, preferably UV light, through the film. Other curing methods and other radiation than UV light can be used provided the curing effect occurs while the film remains in contact with the varnish to imprint the pattern.

In one arrangement, the varnish can cover substantially the whole of the front surface of said at least one opaque scratch-off layer as a solid block. In this case there may be applied additional printed graphics onto parts of the varnish so as to form patterns or graphics on the varnish.

In another case, the varnish may cover only selected areas of the front surface of said at least one opaque scratch-off layer. In this case there can be applied printed graphics between the areas of the varnish. In addition printed graphics can be applied onto parts of the varnish in the selected areas. Alternatively parts of the scratch-off may be left without receiving any varnish or any additional printed layers. The varnish and/or the additional printing may extend also on to the areas of the ticket beyond the game area and the scratch-off layer as a separate printed image or as a continuous image extending contiguously over both areas.

The method may be applied to tickets where the substrate layer includes a foil layer or where the substrate layer includes card or paper stock covered by coatings arranged to prevent access to game data through the substrate.

Preferably in a continuous printing process the film comprises an elongate band of the film which is applied onto a continuous strip of the substrate defining a row of the tickets as the substrate is printed on a printing line. The band can be re-used or can be removed after use and replaced by a fresh band.

In order to ensure that the pattern is properly taken up in the varnish, preferably the band is nipped on to the substrate and is preferably held in place between two pairs of nip rollers at spaced positions along the strip of the substrate with the curing being effected between the nip rollers.

In another alternative, the varnish is applied over the entire coloured overprint layer of the ticket including the scratch-off and even possibly remaining sections of the ticket with nothing exposed.

According to a second aspect of the invention there is provided a lottery ticket comprising:

a substrate layer;

a game area defined on a front surface of the substrate layer;

indicia defining game data printed on the substrate layer in the game area;

at least one fixing layer applied over the game data in the game area which is arranged to prevent release of the printed game data from the substrate layer;

at least one opaque scratch-off layer applied over the fixing layer to provide a front surface thereof, the scratch-off layer being arranged such that it separates from the sealing layer and breaks down into fragments when scratched by a player;

a layer of varnish covering at least a part of said at least one opaque scratch-off layer;

the varnish having an exposed front surface which includes depressions in the surface to varying depths which cause reflected light to diffract and provide a holographic like appearance;

said at least one opaque scratch-off layer with the varnish thereon being arranged such that the scratch-off layer and the varnish separate from the sealing layer and break down into fragments when scratched by a player.

Thus in a typical process, back graphics are applied following which the various coatings required for a lottery ticket are applied to the front surface of the substrate. These coatings would typically include:

Underlying lily-pad consisting of one or more layers;

Variable game play data and other data including ticket number, validation information, etc;

Security coatings including seal-coats and protective varnish(es);

Scratch-off layer(s).

After the top scratch-off layer, another varnish layer is applied to the ticket surface and will cover at least a portion of the scratch-off layer and may include all or a portion of the base graphic area. Following the varnish application and before the varnish is dried or cured, a clear film is brought into contact with the uncured, liquid varnish. The clear film has been micro-embossed on one side which results in minute depressions in the surface of the clear film to varying depths. The embossed side of the clear film is the surface which contacts the varnish coating. Once the film is applied the web of ticket stock, with the film in contact, then proceeds through a nip assembly where the film is pressed into the varnish layer. Immediately following the nip section the varnish is cured, through the clear film, by the ultra-violet process. Once it exits the ultra-violet curing unit the clear film is removed from the web surface leaving the cured varnish exposed. The surface of the varnish is formed to match the embossed image that remains present on the clear film. When the ticket surface is viewed under lighting conditions the resulting embossed surface causes the reflected light to diffract and provide a holographic like appearance.

Once the film is removed additional graphic images can be printed on top of the varnish and can include play instructions, game name, price, etc.

The varnish layer, applied over the scratch-off coatings is removed during the game play process because of the underlying scratch-off coatings.

The above description would be the preferred alternative but other options are certainly available using the same process.

The top varnish layer can be applied across the entire surface of the ticket including both base graphic and scratch-off areas following which the overprint colors are applied.

The varnish can be applied in certain areas, for example on the scratch-off only, portions of scratch-off and base graphic areas, etc. In these cases the holographic-like image will only appear in those particular places on the ticket surface.

The top varnish can be applied over top of the overprinting layer so that the graphic images on the scratch-off and base graphic areas have the holographic effect.

In the base graphic areas the varnish can be applied over colored inks or directly onto the substrate to create different effects in terms of appearance.

In the scratch-off areas the varnish can be applied over the scratch-off or a colored overprinting layer, following which other overprint colors are applied.

The same process can be applied to non-lottery commercial game products or similar devices using a scratch-off coating over data.

The arrangement described in more detail hereinafter may provide one or more of the following features and advantages:

In respect of ticket security, it provides enhanced security in regards to the game play area as follows:

Anti-Color copying;

Tamper evident in case of attempted compromise;

Un-repairable;

Resists lifting of the scratch-off;

Diffracts light sources used in UV or wavelength dependent luminescence;

Compromises attempts using chemicals.

In respect of marketing, lottery tickets are generally an impulse purchase typically done in conjunction with a player's purchase of other goods including gasoline, newspaper, etc. It is important to attract the player's attention quickly as they are standing in front of a cash register completing a different transaction. This product offers a diffractive surface when viewed at different angles and is more easily noticed than standard inks used in lottery tickets. The incorporation of diffractive properties onto the scratch-off surface achieves a greater effect than in the background only because in most cases the game play area, which is the focus of the ticket itself generally, occupies a significant portion of the ticket surface.

The diffractive effect applied by the embossed pattern of the film must overcome the surface properties of a typical scratch-off layer, which is porous, has a matte appearance and is typically applied with patterned anilox rollers which leaves an uneven surface.

The varnish coating can be applied as the last step in the process in which case it would overlap all of the coatings including the overprints. In this case the varnish is applied as a pattern with design features knocked out of the pattern so they remain legible.

It is also an option to apply the coatings under the scratch-off. This would provide increased security to the game play data. This would include data alteration, data replacement and cut/paste techniques.

### BRIEF DESCRIPTION OF THE DRAWINGS

One embodiment of the invention will now be described in conjunction with the accompanying drawings in which:

FIG. 1 is a schematic illustration of a method of manufacturing the lottery ticket of FIG. 2 or 3.

FIG. 2 is the schematic illustration of the layers of a lottery ticket product according to the present invention.

FIG. 3 is a schematic illustration of the layers of a second embodiment of a lottery ticket product according to the present invention.

In the drawings like characters of reference indicate corresponding parts in the different figures.

### DETAILED DESCRIPTION

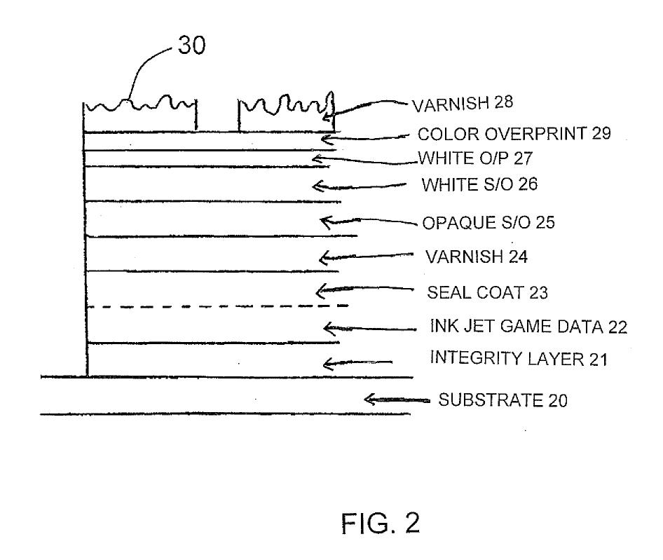

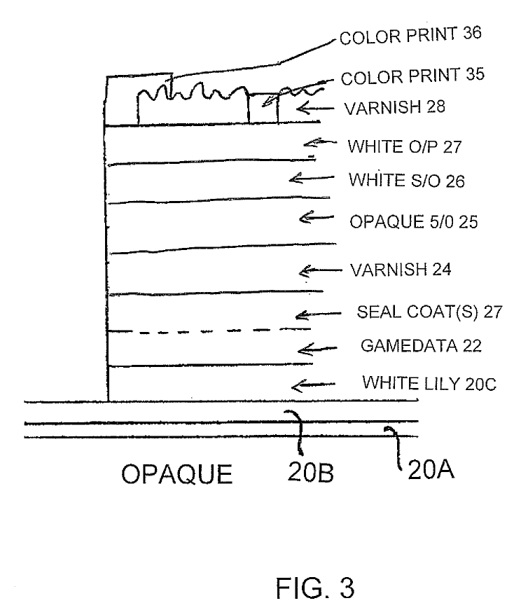

Embodiments of the invention are shown in FIGS. 2 and 3, in FIG. 2 there is shown a ticket formed of a substrate layer 20 on which is applied one or more integrity layers 21 which are designed to resist chemical or fluid attack through a porous substrate such as paper or card stock attempting to access the game data. On top of the integrity layer or layers 21 is applied the printed game data 22 which is covered by one or more fixing layers such as a seal coat 23 and/or varnish 24 which may prevent chemical attack and which lock the game data physically in to place to prevent the game data from being removed by scratching.

On top of the varnish layer 24 is applied one or more scratch off layers 25, 26 which are formed of an opaque or white material. Such opaque scratch off materials are well known and may contain graphite or other black or light impenetrable materials to prevent passage of light in either direction which could reveal information about the game data underneath the scratch-off layers. The scratch-off layers are formed primarily of latex which can breakdown under scratching or friction into fragments. The material itself has no linking materials through its structure so that it cannot be peeled off as a layer but instead simply breaks down into individual fragments or components. Thus the scratch-off layers 25 and 26 together combine to form a scratch-off coating which can be removed in a single scratching action breaking down all of the layers to form the composite fragments which breakaway and are discarded. On top of the scratch-off layers 25, 26 is provided a white over printing layer 27 which forms in effect an undercoat for material covering the scratch-off coatings. The integrity layer or layers, the fixing layer or layers and the scratch-off layer or layers are well known to one skilled in the art such that the selection and use thereof as required in any particular construction can be made by the skilled person using conventional knowledge.

On top of the over printing layer 27 is applied a colored overprint layer 29 which provides either a plane color or a multi-color graphic as chosen.

On top of the colored over printing layer 29 is provided a layer of varnish 28 which has a top or front surface which includes an embossed pattern of a nature which includes depressions in the surface to varying depths which cause reflected light to diffract and provide a holographic like appearance. The varnish layer 28 may cover the entire region of the game area on top of the layer 29 or may be broken into separate sections which cover individual parts of the game area leaving the layer 29 exposed. The varnish layer 28 is reflective or holographic and thus provides an attractive outer surface 30 which is presented toward the player during review of the ticket surface.

The varnish layer is selected and arranged so that it breaks down when scratched with the scratch off layers 25 and 26 together with the over printing layers 27 and 29. Thus the whole of the structure defined by the layers 25, 26, 27, 29 and 28 breaks down into fragments when scratched and cannot be peeled as integral layer.

The varnish therefore has a thickness which is sufficiently thin to prevent the layer from having structural strength and merely provides a decorative coating. The thickness therefore is sufficient simply to provide the reflective appearance or the holographic appearance obtained by embossment. The thickness is therefore preferable less than 0.0005 inch and more preferably in the range 0.0002 to 0.0003 inch.

As the varnish layer 28 is not required to hide the game data, it may be arranged as simple decoration over small parts or larger parts as required of the game area. Additional varnish layer parts may also be applied to other areas of the lottery ticket to match or mirror or co-operate with parts in the game area to provide a whole attractive appearance defined by the total graphics on the lottery ticket.

In FIG. 3 is shown an alternative embodiment similar to that of FIG. 2 in which the card or paper substrate 20 is replaced by a substrate 20A which is covered by a layer of foil 20B. The foil is wholly opaque and moisture impermeable so that there may be no requirement for any layers similar to the integrity layer or layers 21. In their stead is provided a layer 20C simply of a white ink which forms a white base for receiving the game data 22. Again the layers necessary for printing on a foil substrate are known to one skilled in the art.

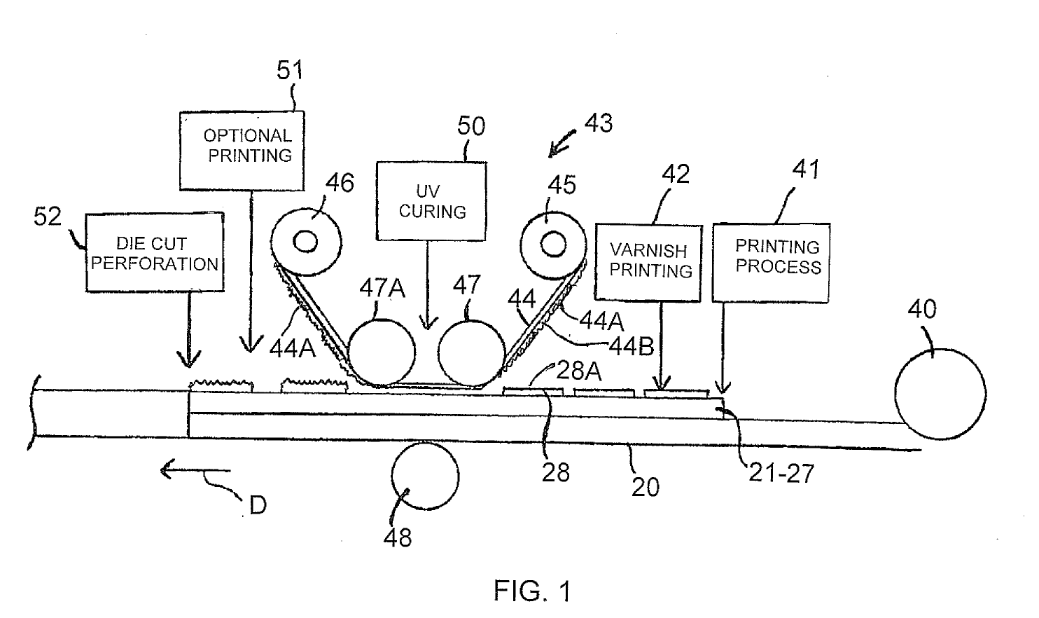

A further modification is shown in FIG. 3 in which additional printing layers 35 and 36 are provided. These can be provided as a replacement for the underlying colored layer 29 of FIG. 1. Thus the whole of the game area is covered by the varnish where exposed and by one or more of the layers 35 and 36. The front surface of the ticket which is visible by the player is therefore defined at various locations across the game area by one of these layers 28, 35 or 36 so that the whole of the game area is either printed in various colours or covered by the reflective varnish layer 28 providing a whole graphics area over the game area.

The printed layer 35 is located only between the varnish sections. The layer 36 is printed over parts of the front face which are free from varnish and partly over the varnish. It will be appreciated that many different arrangements of varnish 28 and printed layers 35, 36 can be used to achieve different effects with the varnish and its holographic front surface forming a part or all of the visible front surface to provide the enhanced visual effect described.

Turning now to FIG. 1 there is shown a method of forming the ticket of FIG. 2. The method includes providing the substrate layer 20 from a supply 40 which is then covered by the layers 21 through 27 by a printing process schematically indicated at 41. On top of the layers 21 through 27 is printed the varnish layer 28 using an varnish printing process 42.

It will be appreciated that varnish is a well known material in printing processes and can be formed of many different materials including natural resins and polymers. It is generally transparent and hard. It can be printed using a traditional printing press using the same techniques as used for printing conventional inks. In this case the varnish is preferably of a type which remains uncured until triggered and curing is triggered by the application of UV light. Such varnishes are typically of the polymer type and are well known in the industry so as to be readily available from many sources. The varnish used may be of the type available from Wikoff Color Corporation.

The varnish thus is generally applied using a flexographic process including a flexographic plate. The flexographic plate, with the desired image, transfers the varnish from the conventional anilox roll to the substrate.

As indicated generally at 43 is provided a system for applying an embossed pattern to a front surface 28A of the printed varnish 28 using a band of a film 44. Thus the film 44 is supplied from a supply roll 45 to a take up roll 46. The film includes an embossed pattern 44A on its front surface 44B. The pattern is continuous over the whole front surface of the film. With the strip of the substrate moving in the direction D, the film 44 is transported under rollers 47 and 47A between which the carrier film 44 and the substrate 20 are pinched relative to a nip roller or rollers 48. This nipping action acts to pinch the varnish 28 so as to apply the imprint of the pattern 44A onto the top surface 28A of the varnish 28 which is at this stage in an uncured condition. The embossed pattern 44A has no effect on the underlying surface of the ticket, generally provided by the layer 29 of FIG. 2, since this material is already cured or set and thus the embossed pattern 44A provides the embossed or holographic effect only at the varnish 28.

The UV curable varnish is rapid cured between the rollers 47 and 47A. A UV curing system 50 is thus provided for applying curing UV light to the varnish through the transparent film 44 while the film in contact with the varnish 28. The optional printing 51 can be provided down stream of the UV curing to apply additional printing layers 34, 35 and/or 36 on top of or between the sections of the varnish 28.

Down stream of the printing process, the tickets are cut or perforated in to separate ticket sections by a dye cutting system generally indicated at 52.

The arrangement described above therefore provides a novel lottery ticket which has suitable scratching characteristics in that the selection of the varnish 28 and the scratch-off coatings 26, 27 is such that all of these layers break away simultaneously into fragments without the possibility for peeling or slicing a complete integral section of the coating away form the game data. The varnish can be selected without the necessity for the varnish being individually scratchable since it breaks down as part of the scratch-off layers. The varnish is selected so that is does not provide an integral layer or skin which can be peeled away but instead breaks down into fragments.

The ticket provides the security system previously established in view of the presence of the layers 21 through 27 which conventionally provide the required security.

The varnish may be used simply as a decorative coating rather than a security or scratch-off coating and therefore may be applied only over a part of the game area giving the opportunity for different graphics effects. However even if the varnish layer is applied to only selected areas it may still provide additional security effects. Thus the presence to the varnish also may further enhance security in that it indicates any attempt to slice away a part or the whole of the scratch-off coatings. Thus one known mode of attack is to utilize a knife to slice off the whole of the scratch-off coating as an integral layer, to read the underlying game data and then to relay the sliced off coating over the game data. The use of a holographic varnish layer having particular reflective characteristics such as the holographic appearance causes the reflective characteristics to be entirely lost when the layer is sliced away due to folding or crumpling or breaking of the varnish layer. Such attempts therefore are immediately visually apparent.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A method of manufacturing a lottery ticket comprising:
providing a substrate layer;
defining a game area on a front surface of the substrate layer
printing indicia defining game data on the substrate layer in the game area;
applying at least one opaque scratch-off layer over the game data,
applying a curable varnish on to an exposed surface of said at least one opaque scratch-off layer;
while the varnish remains uncured, contacting an exposed surface of the varnish with a surface of a film which has the surface thereof embossed to form a pattern;
and, with the film in contact with the varnish, curing the varnish so that the varnish is cured with the pattern of the film formed into the surface of the varnish;
said at least one opaque scratch-off layer with the varnish thereon being arranged such that the scratch-off layer and the varnish separate from the sealing layer and break down into fragments when scratched by a player.

2. The method according to claim 1 wherein said at least one opaque scratch-off layer includes a colored overprint layer and the varnish is applied over at least one part of the colored overprint layer leaving at least one part of the colored overprint layer exposed.

3. The method according to claim 1 wherein the varnish is cured by UV.

4. The method according to claim 1 wherein the film is transparent and the varnish is cured by radiation through the film.

5. The method according to claim 1 wherein the varnish covers substantially the whole of the front surface of said at least one opaque scratch-off layer as a solid block.

6. The method according to claim 5 wherein there is applied additional printed graphics onto parts of the varnish.

7. The method according to claim 2 wherein the varnish covers only one or more selected areas of the front surface of said at least one opaque scratch-off layer and there is applied an additional colored overprint layer defining printed graphics between the areas of the varnish.

8. The method according to claim 7 wherein there is applied additional printed graphics onto parts of the varnish.

9. The method according to claim 1 wherein the substrate layer includes a foil layer.

10. The method according to claim 1 wherein the substrate layer includes card or paper stock covered by coatings arranged to prevent access to game data through the substrate.

11. The method according to claim 1 wherein there is applied additional printed graphics onto parts of the varnish.

12. The method according to claim 1 wherein the film comprises an elongate band of the film which is applied onto a continuous strip of the substrate defining a row of the tickets as the substrate is printed on a printing line.

13. The method according to claim 12 wherein the band is nipped on to the substrate.

14. The method according to claim 1 wherein the varnish is applied over the entire coloured overprint layer of the ticket with nothing exposed.

15. A lottery ticket comprising:
a substrate layer;
a game area defined on a front surface of the substrate layer;
indicia defining game data printed on the substrate layer in the game area;
at least one fixing layer applied over the game data in the game area which is arranged to prevent release of the printed game data from the substrate layer;
at least one opaque scratch-off layer applied over the fixing layer to provide a front surface thereof, the scratch-off layer being arranged such that it separates from the sealing layer and breaks down into fragments when scratched by a player;
a layer of varnish covering at least a part of said at least one opaque scratch-off layer;
the varnish having an exposed front surface which includes depressions in the surface to varying depths which cause reflected light to diffract and provide a holographic like appearance;
said at least one opaque scratch-off layer with the varnish thereon being arranged such that the scratch-off layer and the varnish separate from the sealing layer and break down into fragments when scratched by a player.

16. The lottery ticket according to claim 15 wherein said at least one opaque scratch-off layer includes a colored overprint layer and the varnish is applied over at least one part of the colored overprint layer leaving at least one part of the colored overprint layer exposed.

17. The lottery ticket according to claim 16 wherein the varnish is UV curable.

18. The lottery ticket according to claim 15 wherein the varnish covers substantially the whole of the front surface of said at least one opaque scratch-off layer as a solid block.

19. The lottery ticket according to claim 16 wherein there are additional printed graphics printed onto parts of the varnish.

20. The lottery ticket according to claim 15 wherein the varnish covers only one or more selected areas of the front surface of said at least one opaque scratch-off layer and there are printed graphics between the areas of the varnish.

21. The lottery ticket according to claim 15 wherein the varnish is applied over the entire coloured overprint layer of the ticket with nothing exposed.
